(19) United States
(12) Patent Application Publication
(10) Pub. No.: US 2009/0092437 A1
(43) Pub. Date: Apr. 9, 2009

(54) WRITING IMPLEMENT

(75) Inventor: Judah Isaacs, Lawrence, NY (US)

Correspondence Address: KATTEN MUCHIN ROSENMAN LLP, 575 MADISON AVENUE, NEW YORK, NY, 10022-2585, US

(73) Assignee: INNOVATIVE PREMIUMS INC., Oceanside, NY (US)

(21) Appl. No.: 12/238,570

(22) Filed: Sep. 26, 2008

Related U.S. Application Data
(60) Provisional application No. 60/977,161, filed on Oct. 3, 2007.

(51) Int. Cl. B43K 29/00

(52) U.S. Cl. 401/195

(57) ABSTRACT

A writing implement includes a body portion, display objections disposed in the body portion. Each display object includes a data unit. At least one of the display objects is moveable from a respective first position to a respective second position where the plurality of data units are perceived as a promotional message.

### CROSS-REFERENCE TO RELATED APPLICATIONS

This application is a non-provisional counterpart to and claims priority from U.S. Ser. No. 60/977,161 filed on Oct. 3, 2007, which is pending and which is incorporated by reference in its entirety for all purposes.

### BACKGROUND OF THE INVENTION

1. Field of the Invention

The invention relates generally to writing implements featuring a fluid filled chamber that is fully or partially transparent for displaying one or more objects carrying a promotional message.

2. Discussion of the Prior Art

Writing implements, such as pens, pencils, markers, and the like, are ubiquitous items and are commonly used in marketing campaigns to present desired information, i.e. “a promotional message,” such as product name, slogan, design, logo, or any other advertising and/or information. When made available as a promotional item, the writing implement presents the message every time it is handled by a user.

However, when the message is imprinted on the writing implement, it becomes stale as users become accustomed to it. Providing the message such that it moves is known to create prolonged user interest. For example, U.S. Pat. No. D465,240, which is herein incorporated by reference in its entirety, teaches a pen having a translucent chamber and imprinted items that move in the chamber.

Unfortunately, providing items loosely in the chamber permits the items to become randomly oriented, obscuring the imprint, and reducing the effectiveness of the promotional message.

Thus, what is desired is a writing implement that includes a promotional message that moves and is displayed under specific circumstances.

### BRIEF DESCRIPTION OF THE INVENTION

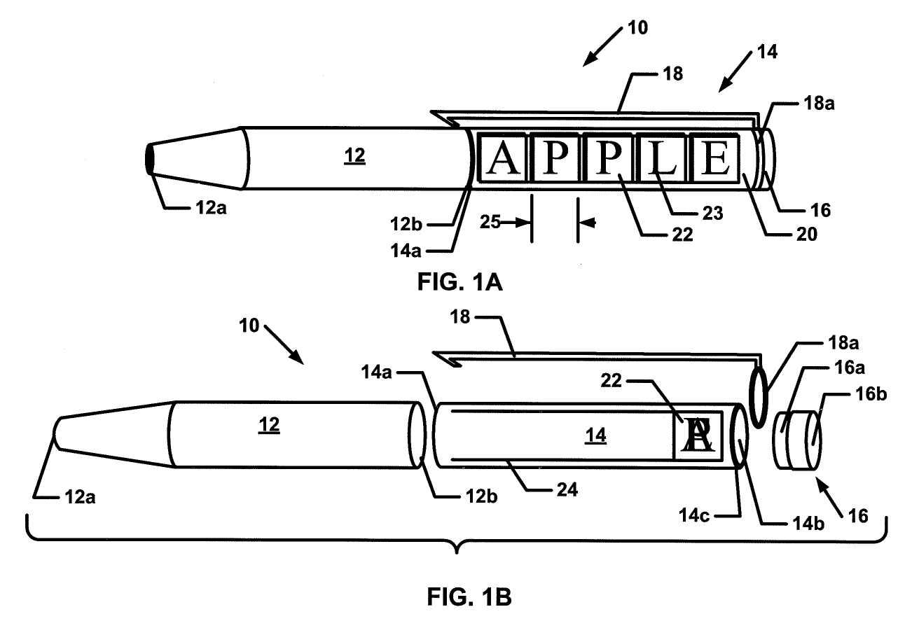

FIG. 1a is an isometric view of a writing implement in accordance with one embodiment of the present invention and having display objects disposed in an unstored position.

FIG. 1b is an isometric view of selected components of an exploded writing implement of FIG. 1a and having display objects disposed in a stored position.

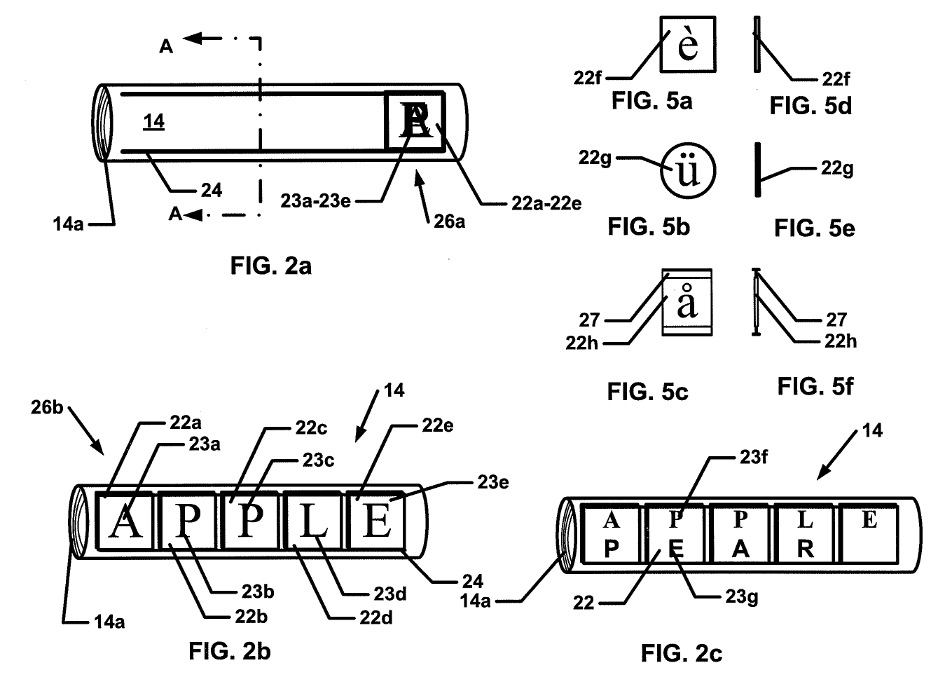

FIGS. 2a and 2b are isometric view of a second barrel portion in accordance with one embodiment of the present invention.

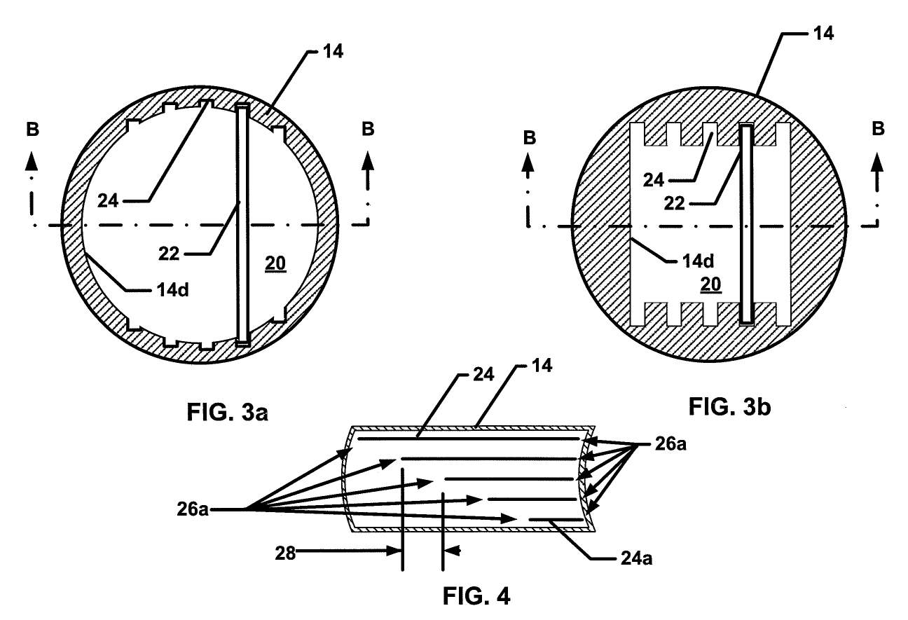

FIG. 3a is a cross-sectional view of a second barrel portion taken along line A-A of FIG. 2b in accordance with one embodiment of the present invention.

FIG. 3b is a cross-sectional view of a second barrel portion taken along line A-A of FIG. 2b in accordance with a further embodiment of the present invention.

FIG. 4 is a cross-sectional view of the guides taken along line B-B of FIG. 3a or 3b in accordance with one embodiment of the present invention.

FIGS. 5a, 5b, and 5c are front views of display objects in accordance with one embodiment of the present invention.

FIGS. 5d, 5e, and 5f are side views of the display objects of FIGS. 5a, 5b, and 5c, respectively.

### DETAILED DESCRIPTION OF THE INVENTION

Reference will now be made in detail to several views of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, left, right, up, down, over, above, below, beneath, rear, and front may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

FIG. 1a is an isometric view of a writing implement in accordance with one embodiment of the present invention and having display objects disposed in an unstored position. FIG. 1b is an isometric view of selected components of an exploded writing implement of FIG. 1a and having display objects disposed in a stored position.

It should be appreciated that “stored position” is not used to connote a position used during travel, inactivity or the like, but rather it connotes that the display objects are not individually perceivable. Also, it should be appreciated that while the application is illustrated with one embodiment having five display objects, more or less display object may be used as needed to convey the promotional message.

Writing implement 10 may be configured as a promotional item and/or an amusement device, known in the art as a “float pen,” i.e. “tilt pen,” and be substantially a pen, pencil, marker, and the like. A promotional message, such as product name, slogan, design, logo, or any other advertising and/or information, comprise one or more data units and is disposed on one or more display objects that move from a first stored position to respective second unstored positions when the writing implement is tilted. Preferably, the second position corresponds at least in part to the position by a user when writing.

Preferably, writing implement 10 comprises barrel-shaped or elongated cylinders configured as a first and second barrel portion 12, 14, respectively. However, the first and second portion of the present invention may have barrel portions with various other shapes and configurations, without limitation.

Each portion may be made of injection molded plastic or other similar material to make writing implement 10 economical to manufacture. However, other materials may also be used and may be coordinated with the promotional message that is being conveyed. For example, natural materials may be used when conveying an ecologically oriented promotional message.

The first barrel portion comprises a hollow body with a respective opening 12a, 12b at each end. A suitable writing assembly as is known in the art is disposed in the hollow body. The assembly preferably comprises a marking or writing element, such as a ballpoint pen, felt-tipped pen, fiber marker, or the like as is known in the art and the necessary mechanical assembly needed to place the writing element in contact with a surface which can be marked. Preferably, the marking or writing element is disposed through opening 12a and may be selectively retractable and extendable by a twisting action as is generally known in the art.

The second barrel portion comprises a first sealed end 14a that preferably includes a means for joining the first barrel portion to the second barrel portion. Thus, ends 12b and 14a may be joined by snap-fit assembly, turn-lock assembly, screw threads (FIGS. 2a and 2b), and/or any other suitable means.

The second barrel portion is preferably transparent and includes an open end 14b that is sealed with a cap 16. Cap 16 maybe configured to have a sealing plug 16a that fits into the opening of open end 14b. A head 16b of the cap captures a securing portion 18a of a clip 18 between the head and a peripheral area 14c of open end 14b.

The cap is preferably secured via glue, sonic welding, and/or any other suitable means to the second barrel portion as is generally know in the art.

A fluid 20 that is preferably transparent and/or translucent is disposed in the second barrel portion 14. Fluid 20 may be a non-toxic, environmentally-neutral fluid and may comprise water, oil, inert fluid, and/or like material. In accordance with one embodiment of the present invention, the fluid comprises a color and/or may be substantially opaque. Embodiments of the present invention are not limited to the use of translucent or transparent fluids.

A plurality of display objects 22 is provided in the second barrel portion. Each object moves from a first stored position to respective unstored positions when the writing implement is tilted. Since the second barrel portion is transparent, the user can observe the assemblage of the promotional message as the display objects move from a first to second position.

Each display object may comprise one or more data units 23. In turn, each data unit may comprise one or more alphabetic or alphanumeric characters, punctuation, designs, colors, and/or any other suitable information, and/or any combination thereof, which is part of a promotional message. When necessary, one or more display objects may be blank to denote a space and/or empty characters.

The promotional message may be displayed on one or more sides of the display objects such that it is visible from more than one side of the writing implement.

The display object preferably comprises a plastic material that is opaque such that a data unit is easily perceived by the user. Thus, data unit 23 may be printed, etched, lacquered, and/or placed by any suitable means to the display object and comprise an ink, lacquer, or any other permanent or temporary marking method. The data unit may be provided in colors, styles, or manner that enhances the data unit vis-à-vis the respective display object.

In accordance with one embodiment of the present invention, the display object comprises a clear material and the data unit is chosen so as to be visible from more than one side of the writing implement.

In accordance with one embodiment of the present invention, the data unit is selected to have a permanent or temporary interaction with fluid 20. For example, the data units emit a glow or appear to emit a glow due to a chemical and/or physical interaction with the fluid or because the combination of color from the fluid and data unit produces a color that catches the user's attention.

FIGS. 2a and 2b are isometric view of a second barrel portion in accordance with one embodiment of the present invention. One or more display objects 22 are disposed in the second barrel portion and travel in guides 24 from a first stored position 26a to respective second unstored positions 26b to display a promotional message.

For example, a promotional message comprises data units 23a-23e spelling the word “APPLE” using display objects 22a-22e. In the first stored position 26a, the data units are not distinctly and/or individually perceivable, but when disposed in the second positions 26b, the data units become easily perceived as the promotional message “APPLE.”

FIG. 2c is an isometric view of a second barrel portion in accordance with one embodiment of the present invention. Therein, two data units 23f and 23g are disposed on one display object 22 to provide a multi-word promotional message of “APPLE PEAR.”

FIG. 3a is a cross-sectional view of a second barrel portion taken along line A-A of FIG. 2b in accordance with one embodiment of the present invention. FIG. 3b is a cross-sectional view of a second barrel portion taken along line A-A of FIG. 2b in accordance with a further embodiment of the present invention.

A plurality of guides 24 is disposed in an inner periphery of second barrel portion 14. The periphery 14d may be formed substantially circular as shown in FIG. 3a and preferably are provided in matching sets. Accordingly, display objects 22 are each formed to have a different size appropriate to span the distance, i.e. height, between matching pairs of guides. For example, the display object 22a may be disposed in guides 24 that are outermost and have a lesser height than display object 22c, which is disposed in the guides that are located central most.

In the alternative, a plurality of guides 24 is formed in any other suitable shape such as the rectangular periphery of FIG. 3b. Thus, each display object may have a substantially identical height and width producing an equal display surface.

FIG. 4 is a cross-sectional view of the guides taken along line B-B of FIG. 3a or 3b in accordance with one embodiment of the present invention. Guides may be disposed in any order that is suitable. Therein, the guide may be staggered and each is separated by a distance 28 that preferable matches a width 25 of a respective display object.

Preferably, to utilize the space of the second barrel portion properly, one guide, guide 24a, is sized so that the display object does not move in the guide. Thus, for this guide the first stored position 26a and second position 26b are identical.

FIGS. 5a, 5b, and 5c are front views of display objects in accordance with one embodiment of the present invention. FIGS. 5d, 5e, and 5f are side views of the display objects FIGS. 5a, 5b, and 5c, respectively.

A display object 22f comprises a rectangular front that serves as a display surface comprising one or more data units 23. The display object may be configured to be a square. In width, the display object may be thin, providing the display object the form of a panel.

A display object 22g is formed to be circular. In width, the display object is thin and the display object may have the form of a disk.

A display object 22h is formed of any convenient shape and includes one or more rails 27 adjacent to the display object. One or all rails are received in matching channels disposed in guides 24 to resist errant dislocation from guides 24.

This document describes the invention for illustrative purposes only. Neither the specific embodiments of the invention as a whole, nor those of its features limit the general principles underlying the invention. In particular, the invention is not limited to any specific configuration disclosed herein. The specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention.

What is claimed is:

1. A writing implement comprising:
a body portion;
a plurality of display objections disposed in the body portion, each display object comprising a data unit;
at least one of the plurality of display objects moveable from a respective first position to a respective second position where the plurality of data units are perceived as a promotional message.

2. The writing implement of claim 1 further comprising a plurality of guides in the body portion, each display object traveling in a respective guide.

3. The writing implement of claim 2, wherein the plurality of guides are disposed in an inner periphery of the body portion.

4. The writing implement of claim 3, wherein the body portion comprises a rectangular inner periphery.

5. The writing implement of claim 3, wherein the body portion comprises a substantially circular inner periphery.

6. The writing implement of claim 1 further comprising a second display object moveable from a respective first position to a respective second position.

7. The writing implement of claim 6, wherein the respective second positions are staggered.

8. The writing implement of claim 7, wherein the respective first positions are disposed at a position that is common with respect to an axis of the body portion.

9. The writing implement of claim 1, wherein each of the display object comprises a square so that the data unit remains in a fixed position relative to the body portion.

10. The writing implement of claim 1, wherein the body portion comprises a fluid, one of the data units having an interaction with the fluid.

11. The writing implement of claim 1, wherein each of the display objects is identically sized.

12. A promotional item, the item comprising:
a first portion comprising a marking element;
a second portion comprising a plurality of guides and a plurality of data units, the plurality of guides having a common first position, each of the plurality of guides having a respective second position staggered from another respective second position,
wherein the plurality data units are displayable at the respective second positions as a promotional message.

13. The promotional item of claim 12, further comprising a plurality of display objects, each display object comprising at least one of the respective data units.

14. The promotional item of claim 13, wherein at least one of the plurality of display objects is moveable in one of the plurality of guides from the first position to the respective second position.

15. The promotional item of claim 12, where at least one of the first positions is coincident with at one of the second positions.

16. The promotional item of claim 12, wherein the guides are provided in an inner periphery of the second portion.

17. A writing implement comprising:
a liquid filled body portion;
a plurality of display objects;
a plurality of guides provided in an inner periphery for permitting at least one of the plurality of display objects to slide in the guides for revealing a promotional message.

18. The writing implement of claim 17, wherein each of the display objects comprises a data unit, the data units forming the promotional message.

19. The writing implement of claim 17, wherein the display objects comprise a rail for being retained in the guide.

20. The writing implement of claim 17, wherein another of the plurality of display objects remains stationary relative to the writing implement.
